(19) United States
(12) Patent Application Publication
(10) Pub. No.: US 2026/0250148 A1
(43) Pub. Date: Aug. 27, 2026

(54) PRODUCTION OF MnSO4

(71) Applicant: INNOVATIVE MANGANESE TECHNOLOGIES SA (PTY) LTD., Cornwall (ZA)

(72) Inventor: Gerard PRETORIUS, Cornwall Hill (ZA)

(21) Appl. No.: 19/161,534

(22) PCT Filed: Feb. 14, 2024
(86) PCT No.: PCT/IB2024/051367

§ 371 Date: Sep. 2, 2025

(30) Foreign Application Priority Data
Mar. 3, 2023 (ZA) 2023/03282

(51) Int. Cl. C01G 45/10; C01C 1/24

(52) U.S. Cl. CPC C01G 45/10; C01C 1/24; C01P 2006/80

(57) ABSTRACT

This invention relates to a process for the production of MnSO₄, in particular a high purity battery grade anhydrous MnSO₄ having a purity of between 99.95% to 99.99%. The invention further extends to a product produced by the process.

THIS INVENTION relates to the production of MnSO₄. In particular, the invention relates to a process for recovering a high-purity MnSO₄ product from a MnSO₄ solution.

MnSO₄ is a valuable salt. Apart from extensive use in the metal and alloy industry, the need for MnSO₄ in the electrochemical battery industry is also growing.

Most processes which produce battery-grade MnSO₄·H₂O (manganese sulfate monohydrate) end with a crystallization step. In this crystallization step, the MnSO₄·H₂O crystals are recovered from a saturated solution. The MnSO₄·H₂O crystals are however too fine (typically less than 45 μm) to separate effectively from solution by means of centrifugation, and a filter press is thus typically used for the recovery of the MnSO₄·H₂O crystals. Unfortunately, the MnSO₄·H₂O crystals behave in a thixotropy manner when mechanical forces are exerted on them resulting in a poor recovery thereof. The MnSO₄·H₂O crystals are also very soluble in water (about 52 g/100 ml at 5° C., and about 70 g/100 ml at 70° C.), leading to high losses when the crystals are washed. The inventor understands that “battery grade” MnSO₄·H₂O crystals currently have a purity of about 99.00% such that there is at least about 10 000 ppm of impurities in the crystals. This too is disadvantageous.

A process for recovering a high-purity MnSO₄ product from a MnSO₄ solution, which does not suffer, or which suffers to a lesser extent, from at least some of the aforementioned difficulties, would be desirable.

The reference to “high purity” herein refers to battery grade MnSO₄ crystals having a purity of greater than 99.10%. Preferably it means a purity of greater than 99.95%, more preferably between 99.95% and 99.99%.

According to one aspect of the invention, there is provided a process for recovering a high-purity MnSO₄ product from a feed of an MnSO₄ solution contaminated with one or more alkali or alkaline earth metal contaminants, the process including:

recovering crystals of a first double salt of the divalent cation Mn²⁺ and a monovalent cation and the SO₄²⁻ anion from a first aqueous MnSO₄ solution contaminated with one or more alkali or alkaline earth metals, wherein the crystals of the recovered double salt have a larger particle size than that of crystals of MnSO₄·H₂O when crystallized from said first aqueous solution in the absence of said monovalent cation;
redissolving the first double salt in water or in an aqueous solution to form a second aqueous solution;
crystallising the second aqueous solution to form crystals of a second double salt in a suspension; and
recovering said high-purity MnSO₄ product in anhydrous form from the suspension.

The monovalent cation may be NH₄⁺.

Thus, the first double salt may be MnSO₄·(NH₄)₂SO₄·6H₂O, i.e. manganese ammonium sulfate hexahydrate, also written as (NH₄)₂[Mn(H₂O)₆](SO₄)₂. This Tutton's salt has a pale pink colour and a specific density of about 1.827. Advantageously, the solubility of MnSO₄·(NH₄)₂SO₄·6H₂O in water is less than that of MnSO₄·H₂O, at the same temperature and acts as a carrier for the MnSO₄.

In order to obtain MnSO₄·(NH₄)₂SO₄·6H₂O as the double salt, it is necessary for the first aqueous MnSO₄ solution to include (NH₄)₂SO₄. During concentration of the first aqueous MnSO₄ solution (which thus includes (NH₄)₂SO₄), the first aqueous MnSO₄ solution may be concentrated to a concentration of at least about 10% by mass (NH₄)₂SO₄, preferably at least about 11% by mass (NH₄)₂SO₄, more preferably at least about 12% by mass (NH₄)₂SO₄, e.g. about 13% by mass (NH₄)₂SO₄.

The high-purity MnSO₄ product in anhydrous form may include or may be 2MnSO₄·(NH₄)₂SO₄, which is the second double salt. Advantageously, a contaminant such as Mg does not co-crystalise with 2MnSO₄·(NH₄)₂SO₄ and remains in solution in the second aqueous solution.

According to a preferred aspect of the invention, there is provided a process for recovering a high-purity MnSO₄ product from a feed of an MnSO₄ and (NH₄)₂SO₄ solution contaminated with one or more alkali or alkaline earth metal contaminants, the process including:
recovering crystals of a first double salt of the divalent cation Mn²⁺ and a monovalent cation being NH₄+ and the SO₄²⁻ anion from a first aqueous solution of MnSO₄ and (NH₄)₂SO₄ contaminated with one or more alkali or alkaline earth metals, wherein the crystals of the first recovered double salt have a larger particle size than that of crystals of MnSO₄·H₂O when crystallized from said first aqueous solution in the absence of said monovalent cation;
redissolving the first double salt in water or in an aqueous solution to form a second aqueous solution;
crystallising the second aqueous solution to form crystals of a second double salt in a suspension; and;
recovering said high-purity MnSO₄ product in anhydrous form from the suspension.

Typically, the high-purity MnSO₄ product in anhydrous form is a solid material, e.g. a powder.

The one or more alkali or alkaline earth metal contaminants may be one or more of Li, Na, K, Mg, Ca.

The first aqueous solution contaminated with one or more alkali or alkaline earth metal contaminants may include other contaminants, e.g. Si, Al, Fe, Co, Ni, Cu and Zn. Some of the contaminants, e.g. Mg, Co, Fe, Ni, Cu and Zn also form double salts with the SO₄²⁻ anion. It is thus to be expected that the double salt recovered from the first aqueous solution would be contaminated with one or more of these contaminants. Advantageously however, contaminants such as Na and Ca do not form double salts with the SO₄²⁻ anion, remaining in solution in the first aqueous MnSO₄ and (NH₄)₂SO₄ solution.

Recovering crystals of the first double salt of the divalent cation Mn²⁺ and a monovalent cation being NH₄+ and the SO₄²⁻ anion from the first aqueous solution of MnSO₄ and (NH₄)₂SO₄ may include concentrating the first aqueous solution.

Concentrating the first aqueous solution may include evaporating water from the first solution to provide a concentrated solution.

Preferably, the water is evaporated under vacuum. The vacuum may be at an absolute pressure of less than about 50 kPa, preferably less than about 40 kPa, more preferably less than about 25 kPa, e.g. about 10 kPa.

The water may be evaporated at a temperature of at least about 30° C., preferably at least about 40° C., more preferably at least about 45° C., e.g. about 50° C. Typically, the water is evaporated at a temperature which does not exceed about 55° C.

The first aqueous solution may be concentrated to a concentration of at least about 10% by mass MnSO₄, preferably at least about 11% by mass MnSO₄, more preferably at least about 12% by mass MnSO₄, e.g. about 13% by mass MnSO₄.

Recovering crystals of the first double salt of the divalent cation Mn²⁺ and a monovalent cation being NH₄⁺ and the SO₄²⁻ anion from the first aqueous solution may include crystallizing said first double salt from the concentrated solution.

Crystallizing said first double salt from the concentrated solution may be effected at a first temperature T1. The first temperature T1 may be less than about 30° C., preferably less than about 25° C., more preferably less than about 20° C., most preferably less than about 15° C., e.g. about 10° C. Typically, the first temperature T1 is not less than about 5° C. and lies between 5° C. and 15° C.

Recovering crystals of the first double salt of the divalent cation Mn²⁺ and a monovalent cation being NH₄⁺ and the SO₄²⁻ anion from the first aqueous solution may include centrifugation to separate said first double salt crystals from the first aqueous solution. Instead, or in addition, the first aqueous solution may be subjected to filtration to recover the crystals of the first double salt.

The crystals of the first double salt may have a D₅₀ particle size of at least about 300 μm, preferably at least about 400 μm, more preferably at least about 450 μm, e.g. 480-530 μm. Advantageously, these large double salt particles or crystals are easily separated from the first aqueous solution by centrifugation.

Recovering the crystals of the first double salt of the divalent cation Mn²⁺ and a monovalent cation being NH₄⁺ and the SO₄²⁻ anion from the first aqueous solution may include washing the first double salt crystals obtained from the first aqueous solution. The first double salt crystals obtained from the first aqueous solution may be washed with water.

Redissolving the first double salt in water or in an aqueous solution to form a 15 second aqueous solution may include dissolving the first double salt in water or in an aqueous solution at a temperature of at least about 30° C., preferably at least about 40° C., more preferably between about 45° C. and about 55° C. At higher temperatures, the solubility of the double salt decreases.

If an aqueous solution is used to redissolve the first double salt, the aqueous solution may be the first aqueous solution from which the first double salt crystals have been removed. This implies that the process may include heating the first aqueous solution from which the first double salt crystals have been removed, before using the heated first aqueous solution from which the first double salt crystals have been removed to redissolve the first double salt.

Redissolving the first double salt in water or in an aqueous solution to form a second aqueous solution may include agitating the second aqueous solution.

The second aqueous solution may be subject to crystallisation in order to form a second double salt in a suspension. The second double salt is 2MnSO₄·(NH₄)₂SO₄. It will be appreciated that the second double salt is in anhydrous form.

Crystallisation of the second double salt from the second aqueous solution may include concentrating the second aqueous solution, e.g. by means of evaporation or by means of vacuum evaporation. As will be appreciated, at the relatively high temperature of the second aqueous solution, the partial pressure of water is high, leading to significant evaporation of water, even in the absence of boiling.

The crystallisation of the second aqueous solution is conducted at a second temperature T2. The second temperature T2 may be higher than the first temperature T1.

The second temperature T2 may be at least about 85° C., preferably at least about 90° C., more preferably at least about 95° C., e.g. about 97° C. Typically, the second temperature T2 does not exceed about 110° C.

Recovering crystals of the second double salt from the suspension may include centrifugation. Instead, or in addition, the suspension may be subjected to filtration to recover the crystals of the second double salt.

The crystals of the second double salt may have a D₅₀ particle size of between about 160 μm and about 300 μm, preferably between about 180 μm and about 280 μm, more preferably between about 200 μm and about 260 μm, e.g. about 220-240 μm.

Recovering the crystals of the second double salt in anhydrous form from the suspension may include washing the crystals of the second double salt. The crystals may be washed with water.

The process may further include decomposing the anhydrous second double salt to produce anhydrous MnSO₄. The process of the invention may thus be a process for producing high-purity anhydrous MnSO₄ from a MnSO₄ and (NH₄)₂SO₄ solution contaminated with one or more alkali or alkaline earth metal contaminants. The anhydrous MnSO₄ may be battery-grade MnSO₄.

Decomposing the high-purity MnSO₄ product may be effected by heating the anhydrous second double salt to a temperature of at least about 300° C., preferably at least about 400° C., more preferably at least about 450° C., e.g. about 500-550° C., to produce anhydrous MnSO₄. Typically, the anhydrous second double salt is heated to a temperature that does not exceed about 600° C.

The process may include scrubbing an off-gas produced by the decomposition of the second double salt with water to produce a recovered aqueous (NH₄)₂SO₄ solution. As will be appreciated, said off-gas typically includes SO₂, O₂ and NH₃. The (NH₄)₂ SO₄ solution may be recycled into the first step of the process herein described i.e. preparing a first aqueous solution.

The process may thus include adding an aqueous (NH₄)₂SO₄ solution to a feed MnSO₄ solution to form said first aqueous MnSO₄ solution.

The first aqueous solution may be a leach solution or a pregnant leach solution.

The process may include recycling the recovered aqueous (NH₄)₂SO₄ solution to form part of said first aqueous solution.

The process may include removing potassium from the first aqueous solution, e.g. by means of a jarosite precipitation step. Potassium unfortunately cannot be prevented from remaining as a contaminant at an undesirably high level in the high-purity MnSO₄ product in anhydrous form by means of the crystallisation steps hereinbefore described.

The process of the invention can be implemented on a batch basis, a semi-batch basis, or as a continuous process.

The invention extends to a high-purity MnSO₄ product produced by the process as hereinbefore described.

The invention further extends to anhydrous MnSO₄ produced by the process as hereinbefore described.

In a preferred form of the invention, there is provided a process for recovering a high-purity MnSO₄ product from a feed of a first aqueous solution of MnSO₄ and (NH₄)₂SO₄ contaminated with one or more alkali or alkaline earth metal contaminants, the process including:
(a) recovering crystals of a first double salt of the divalent cation Mn²⁺ and a monovalent cation being NH⁴⁺ and the SO₄²⁻ anion from the first aqueous solution of MnSO₄ and (NH₄)₂SO₄ contaminated with one or more alkali or alkaline earth metals, wherein the crystals of the first recovered double salt have a larger particle size than that of crystals of MnSO₄·H₂O when crystallized from said first aqueous solution in the absence of said monovalent cation;
(b) redissolving the first double salt in water or in an aqueous solution to form a second aqueous solution;
(c) crystallising the second aqueous solution to form anhydrous crystals of a second double salt in a suspension; and
(d) recovering a high-purity MnSO₄ product in anhydrous form from the suspension.

The first aqueous solution is concentrated by evaporation under a vacuum such that the first aqueous solution has an MnSO₄ concentration selected from the group consisting of at least about 10% by mass MnSO₄, at least about 11% by mass MnSO₄, at least about 12% by mass MnSO₄, and at least about 13% by mass MnSO₄.

The recovered crystals of the first double salt from the first aqueous solution have a D₅₀ particle size selected from the group consisting of at least about 300 μm, at least about 400 μm, at least about 450 μm and between 480-530 μm. The crystals of the first double salt are recovered from a crystallisation of the first aqueous solution. The crystallisation of the first aqueous solution takes place at a temperature of between 5° C. and 15° C.

The crystals of the second double salt have a D₅₀ particle size selected from the group consisting of at least about 160 μm, at least about 300 μm, at least about 180 μm and about 280 μm, at least about 200 μm and about 260 μm and at least about 220-240 μm.

The crystals of the second double salt are subject to decomposition with water to produce a high purity anhydrous MnSO₄ product. The decomposition takes place at a temperature of about 500° C. to 550° C.

An off-gas produced by the decomposition of the crystals of the second double salt with water produces an aqueous (NH₄)₂SO₄ solution which is recoverable. The aqueous (NH₄)₂SO₄ solution is recovered and recycled into the first aqueous solution.

The invention will now be described with reference to the following Example and the single diagrammatic drawing.

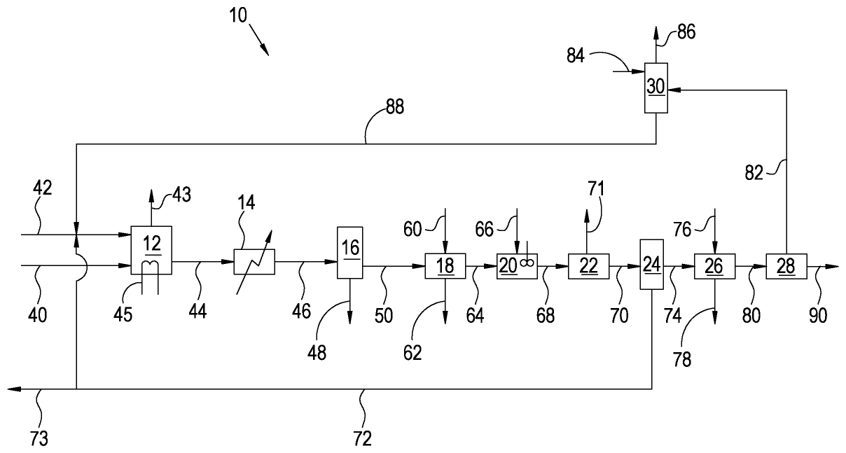

FIG. 1: is a process flow diagram of a continuous process for recovering a high-purity MnSO₄ product in the form of anhydrous manganese sulfate from a solution of MnSO₄ and (NH₄)₂SO₄ contaminated with one or more alkali or alkaline earth metal contaminants.

### EXAMPLE

A relatively clean pregnant leach solution of 12.09% by weight MnSO₄ and 14.43% by weight (NH₄)₂SO₄ was used in a laboratory experiment. This first aqueous solution was concentrated by means of evaporation at 50° C. under vacuum and then cooled to 10° C. to produce crystals of the first double salt MnSO₄·(NH₄)₂SO₄·6H₂O, i.e. 1:1:6 crystals. Large crystals with a D₅₀ of 480-530 μm were obtained which could easily be separated from the pregnant leach solution by centrifugation. The crystals of the first double salt showed a lower solubility in cold water compared to that of MnSO₄·H₂O and were stable under mechanical pressures. The crystals of the first double salt were washed in water and as shown in Table 1 below, the washed crystals were of improved purity compared to the pregnant leach solution, when considering impurities such as Na and Ca which do not form double salts with (NH₄)₂SO₄.

TABLE 1
Unwashed and washed elemental composition of 1:1:6 crystals.

| | | Concentration | Concentration | Concentration |
|---|---|---|---|---|
| | | in pregnant | in unwashed | in washed |
| Component | Units | leach solution | crystals | crystals |
| MnSO₄ | weight | 12.06 | 36.2 | 37.65 |
| | % | | | |
| (NH₄)₂SO₄ | weight | 14.4 | 37.2 | 35.67 |
| | % | | | |
| Na | Ppm | 453 | 10 | 2.4 |
| K | Ppm | 60 | 89 | 89 |
| Mg | Ppm | 28 | 119 | 128 |
| Ca | Ppm | 66 | <1 | <1 |

To address the problem of the inclusion of impurities which also form double salts, such as Mg, the 1:1:6 crystals of the first double salt were redissolved in hot water to form an aqueous solution and crystallized, after allowing to concentrate slightly as a result of evaporation, at 97° C. to produce crystals of a second double salt of 2MnSO₄·(NH₄)₂SO₄, i.e. 2:1 crystals which are in anhydrous form. The remaining impurities (other than K) present at undesirably high levels in the first double salt 1:1:6 crystals, e.g. Mg, did not co-crystallise with the second double salt 2MnSO₄·(NH₄)₂SO₄ crystals and remained in the aqueous solution. The aqueous solution can be recycled back into fresh MnSO₄ pregnant leach solution to restart the 1:1:6 crystallisation process for the first double salt.

The second double salt 2MnSO₄·(NH₄)₂SO₄ crystals crystallized with a D₅₀ of 220-240 μm and were easily separated from the aqueous solution by centrifugation. The second double salt 2MnSO₄·(NH₄)₂SO₄ crystals showed lower solubility in water at a temperature above 90° C., compared to that of MnSO₄·H₂O and were stable under mechanical pressures. The washed second double salt 2MnSO₄·(NH₄)₂SO₄ crystals were of improved purity compared to the aqueous solution from which they were obtained, when considering impurities such as Na, Mg and Ca, as shown in Table 2 below.

TABLE 2
Unwashed and washed elemental composition of 2:1 crystals.

| | | | Concentration | Concentration |
|---|---|---|---|---|
| | | Aqueous | in unwashed | in washed |
| Component | Units | solution | crystals | crystals |
| MnSO₄ | weight % | 8.36 | 64.5 | 65.14 |
| (NH₄)₂SO₄ | weight % | 20.8 | 32.60 | 32.89 |
| Na | ppm | 5.6 | 2.7 | 2.4 |
| K | ppm | 14 | 139 | 141 |
| Mg | ppm | 107 | 37 | 35 |
| Ca | ppm | 6.1 | <1 | <1 |

The anhydrous second double salt 2:1 crystals were decomposed at 550° C. to produce anhydrous battery-grade MnSO₄ and an off-gas which included SO₂, O₂ and NH₃.

As can be seen in Table 1 and Table 2, potassium (K) cannot be removed from the MnSO₄ via the two crystallisation steps. However, potassium can be removed before these crystallisation steps via the well-known jarosite precipitation process.

Referring to the single diagrammatic drawing, reference numeral 10 generally indicates a continuous process in accordance with the invention for recovering a high-purity MnSO₄ product (i.e. battery-grade anhydrous MnSO₄) from a MnSO₄ and (NH₄)₂SO₄ solution contaminated with one or more alkali or alkaline earth metal contaminants.

The process 10 broadly includes a vacuum evaporator 12, a cooler 14, a first centrifuge 16, a first wash stage 18, an agitated dissolution stage 20, a precipitation stage 22, a second centrifuge 24, a second wash stage 26, a rotary furnace 28 and a scrubber 30.

A pregnant manganese sulfate (MnSO₄) leach solution feed line 40 and an ammonium sulfate ((NH₄)₂SO₄) solution feed line 42 lead to the vacuum evaporator 12. The vacuum evaporator 12 is provided with a water vapour withdrawal line 43 and with a heating coil 45.

A suspension transfer line 44 leads from the vacuum evaporator 12 to the cooler 14, and a cooled suspension transfer line 46 leads from the cooler 14 to the first centrifuge 16.

The first centrifuge 16 is provided with a solution withdrawal line 48 and a crystal transfer line 50 which leads to the first wash stage 18.

The first wash stage 18 is provided with a wash water feed line 60 and a wastewater withdrawal line 62.

A washed crystal line 64 leads from the first wash stage 18 to the dissolution stage 20, which is also provided with a solvent feed line 66.

A solution transfer line 68 leads from the dissolution stage 20 to the precipitation stage 22, with a suspension transfer line 70 leading from the precipitation stage 22 to the second centrifuge 24. The precipitation stage 22 is also provided with a water vapour withdrawal line 71.

An ammonium sulfate solution recycle line 72 leads from the second centrifuge 24 to the ammonium sulfate feed line 42, and a crystal transfer line 74 leads from the second centrifuge 24 to the second wash stage 26.

The second wash stage 26 is provided with a wash water feed line 76 and a wastewater withdrawal line 78.

A washed crystal line 80 leads from the second wash stage 26 to the rotary furnace 28, which is provided with an anhydrous MnSO₄ withdrawal line 90 and an off-gas withdrawal line 82.

The off-gas withdrawal line 82 leads into the scrubber 30, which is provided with a water feed line 84, a vent line 86 and an ammonium sulfate solution recycle line 88.

In the process 10, an aqueous, pregnant leach solution of manganese sulfate (with a MnSO₄ concentration for example of about 12.1% by mass) is fed by means of the pregnant manganese sulfate leach solution feed line 40 into the vacuum evaporator 12. The pregnant leach solution includes various contaminants, such as Na, Mg and Ca, typically in the ppm range.

An aqueous ammonium sulfate solution (with an (NH₄)₂SO₄ concentration for example of about 14.4% by mass) is also fed into the vacuum evaporator 12, by means of the ammonium sulfate solution feed line 42. The manganese sulfate and the ammonium sulfate are thus fed into the vacuum evaporator 12 at more or less a stochiometric molar ratio of about 1:1, or with the ammonium sulfate being slightly in excess, say about 25% in excess. As a result of the admixing of the aqueous pregnant leach solution of manganese sulfate and the aqueous ammonium sulfate solution in the vacuum evaporator 12, the concentration of the MnSO₄ and of the ammonium sulfate is significantly reduced.

In the vacuum evaporator 12, an admixture solution of the ammonium sulfate and the manganese sulfate (i.e. a first aqueous MnSO₄ and (NH₄)₂SO₄ solution contaminated with one or more alkali or alkaline earth metals) is concentrated under vacuum at an absolute pressure of about 12 kPA, at a temperature of about 50° C. Heat for the evaporation is provided by the heating coil 45, which may for example be a steam heating coil or an electric heating coil. Water vapour is withdrawn from the vacuum evaporator 12 by means of the water vapour withdrawal line 43, which is also used to draw the vacuum in the vacuum evaporator 12.

The admixture solution is concentrated in the vacuum evaporator 12 to about 13% by mass MnSO₄ and a slightly higher concentration of (NH₄)₂SO₄ and then transferred by means of the suspension transfer line 44 to the cooler 14. In the cooler 14, the admixture solution is cooled to a temperature of about 10° C., using chilled water, leading to saturation and the precipitation of crystals of the first double salt MnSO₄·(NH₄)₂SO₄·6H₂O.

These hexahydrate first double salt crystals (i.e. 1:1:6 crystals) are large with a D₅₀ of about 480 μm to about 530 μm and are transferred by means of the cooled suspension transfer line 46 to the first centrifuge 16. In the first centrifuge 16, the MnSO₄·(NH₄)₂SO₄·6H₂O first double salt crystals are easily separated from the admixture solution, and transferred to the first wash stage 18 by means of the crystal transfer line 50.

The remaining admixture solution is withdrawn from the first centrifuge 16 by means of the solution withdrawal line 48. This withdrawn admixture solution can be treated in a reverse osmosis plant or stage (not shown) to produce a concentrated MnSO₄/(NH₄)₂SO₄ solution, which can be recycled (not shown) to the vacuum concentrator 12. The withdrawn admixture solution in the withdrawal line 48 however includes contaminants such as dissolved Na and Ca, which do not form double salts with ammonium sulfate. A bleed stream (not shown) can be used to prevent build-up of these contaminants in the process 10.

In the first wash stage 18, the first double salt crystals of MnSO₄·(NH₄)₂SO₄·6H₂O are washed with clean water at ambient temperature fed by means of the wash water feed line 60. Waste wash water is withdrawn from the first wash stage 18 by means of the wastewater withdrawal line 62 and washed of the first double salt crystals of MnSO₄·(NH₄)₂SO₄·6H₂O are transferred by means of the washed crystal line 64 to the agitated dissolution stage 20. Advantageously, the solubility of the first double salt crystals of MnSO₄·(NH₄)₂SO₄·6H₂O in water at the operating temperature of the first wash stage 18 is less than that of MnSO₄·H₂O.

In the agitated dissolution stage 20, the washed first double salt MnSO₄·(NH₄)₂SO₄·6H₂O crystals are redissolved in hot water fed by means of the solvent feed line 66 into the agitated dissolution stage 20. The hot water is almost at boiling temperature.

A solution (i.e. a second aqueous solution) formed inside the agitated dissolution stage 20 is transferred by means of the solution transfer line 68 to the precipitation stage 22, where the solution is allowed to concentrate slightly as a result of evaporation of water, to become saturated. The concentration can be effected at atmospheric pressure or, if desired, under a slight vacuum, produced by withdrawing water vapour through the water vapour withdrawal line 71. The concentration of the second aqueous solution in the precipitator stage 22 leads to crystallisation at a temperature of about 97° C. Crystals of the 2MnSO₄·(NH₄)₂SO₄ second double salt (i.e. second double salt 2:1 crystals) precipitate from the solution when saturated and a suspension of the second 2MnSO₄·(NH₄)₂SO₄ double salt crystals is transferred by means of the suspension transfer line 70 to the second centrifuge 24. The second 2MnSO₄·(NH₄)₂SO₄ double salt crystals have a D₅₀ of about 220 μm to about 240 μm.

In the second centrifuge 24, the crystals of the second double salt of 2MnSO₄·(NH₄)₂SO₄ are easily separated from remaining ammonium sulfate solution, with the ammonium sulfate solution being recycled by means of the ammonium sulfate solution recycle line 72 to the vacuum evaporator 12. The recycle ammonium sulfate solution includes contaminants or impurities such as dissolved Mg which form double salts with ammonium sulfate, but which do not co-crystallise with the second double salt 2MnSO₄·(NH₄)₂SO₄ crystals. A bleed stream 73 going to waste is used to prevent build-up of contaminants or impurities such as magnesium in the process 10.

The second double salt 2MnSO₄·(NH₄)₂SO₄ crystals, advantageously with a lower solubility in water than MnSO₄·H₂O at the operating temperature of the second wash stage 26, are transferred by means of the crystal transfer line 74 from the second centrifuge 24 to the second wash stage 26. In the second wash stage 26, the second double salt 2MnSO₄·(NH₄)₂SO₄ crystals are washed with clean wash water, at a temperature of about 90-95° C. fed by means of the wash water feed line 76. Waste wash water is withdrawn by means of the wastewater withdrawal line 78 and the washed second double salt 2MnSO₄·(NH₄)₂SO₄ crystals are transferred by means of the washed crystal line 80 to the rotary furnace 28. It is to be appreciated that the second wash stage 26 is an optional process feature.

In the rotary furnace 28, the washed, anhydrous second double salt 2MnSO₄·(NH₄)₂SO₄ crystals are decomposed at a temperature of about 550° C. thereby producing anhydrous battery-grade MnSO₄, which is withdrawn by means of the anhydrous MnSO₄ withdrawal line 90. Off-gas from the rotary furnace 28 is withdrawn by means of the off-gas withdrawal line 82 and fed to the scrubber 30. The scrubber 30 is also provided with water by means of the water feed line 84. The off-gas from the rotary furnace 28 includes NH₃ and SO₂ and these components are scrubbed from the off-gas with water in the scrubber 30, producing an ammonium sulfate solution which is recycled by means of the ammonium sulfate solution recycle line 88 to the vacuum evaporator 12, and cleaned off-gas which is vented to the atmosphere by means of the vent line 86.

The process 10, as illustrated, advantageously produces battery-grade anhydrous MnSO₄ with low concentrations of sodium, magnesium and calcium. The crystals formed in the cooler 14 and in the precipitation stage 22 are conveniently of a relatively large size, compared to that of MnSO₄·H₂O, providing for easy separation from solution in the first centrifuge 16 and in the second centrifuge 24. These crystals are also of a lower solubility in water at relevant operating temperatures of the process 10, compared to MnSO₄·H₂O at said operating temperatures, which reduces losses during washing. In addition, the crystals are stable under mechanical forces and do not exhibit thixotropic behaviour, which would allow the crystals to be separated from solution by means of filter presses if desired.

1. A process for recovering a high-purity MnSO₄ product from a feed of a first aqueous solution of MnSO₄ and (NH₄)₂SO₄ contaminated with one or more alkali or alkaline earth metal contaminants, the process including:
(a) recovering crystals of a first double salt of the divalent cation Mn²⁺ and a monovalent cation being NH⁴⁺ and the SO₄²⁻ anion from the first aqueous solution of MnSO₄ and (NH₄)₂SO₄ contaminated with one or more alkali or alkaline earth metals, wherein the crystals of the first recovered double salt have a larger particle size than that of crystals of MnSO₄·H₂O when crystallized from said first aqueous solution in the absence of said monovalent cation;
(b) redissolving the first double salt in water or in an aqueous solution to form a second aqueous solution;
(c) crystallising the second aqueous solution to form anhydrous crystals of a second double salt in a suspension; and
(d) recovering a high-purity MnSO₄ product in anhydrous form from the suspension.

2. The process of claim 1, wherein the first aqueous solution is concentrated by evaporation under a vacuum such that the first aqueous solution has an MnSO₄ concentration selected from the group consisting of at least about 10% by mass MnSO₄, at least about 11% by mass MnSO₄, at least about 12% by mass MnSO₄, and at least about 13% by mass MnSO₄.

3. The process of claim 1, wherein the crystals of the first double salt are recovered from a crystallisation of the first aqueous solution.

4. The process of claim 3, wherein the crystallisation of the first aqueous solution takes place at a temperature of between 5° C. and 15° C.

5. The process of claim 1, wherein the recovered crystals of the first double salt from the first aqueous solution have a D₅₀ particle size selected from the group consisting of at least about 300 μm, at least about 400 μm, at least about 450 μm and between 480-530 μm.

6. The process of claim 1, wherein the crystals of the second double salt have a D₅₀ particle size selected from the group consisting of at least about 160 μm, at least about 300 μm, at least about 180 μm and about 280 μm, at least about 200 μm and about 260 μm and at least about 220-240 μm.

7. The process of claim 1, wherein the crystals of the second double salt are subject to decomposition with water to produce a high purity anhydrous MnSO₄ product.

8. The process of claim 7, wherein the decomposition takes place at a temperature of about 500° C. to 550° C.

9. The process of claim 7, where an off-gas produced by the decomposition of the crystals of the second double salt with water produces an aqueous (NH₄)₂SO₄ solution which is recoverable.

10. The process of claim 8, wherein the aqueous (NH₄)₂SO₄ solution is recovered and recycled into the first aqueous solution.

11. A high-purity anhydrous MnSO₄ produced by the process according to claim 1.
